(19) United States
(12) Patent Application Publication
(10) Pub. No.: US 2010/0058411 A1
(43) Pub. Date: Mar. 4, 2010

(54) SYSTEM AND METHOD SUPPORTING DYNAMIC DELIVERY OF PROGRAM TIME TABLES AND BROADCAST PROGRAMS

(76) Inventors: Byung-Tak Lee, Gyeonggi-do (KR); Ho-Young Song, Daejeon-city (KR); Bong-Tae Kim, Daejeon-city (KR); Sung-Yong Lee, Gangwon-do (KR); Byong-Kwon Moon, Gwangju-city (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/514,443

(22) PCT Filed: Dec. 6, 2006
(86) PCT No.: PCT/KR2006/005252

§ 371 Date: May 11, 2009

(30) Foreign Application Priority Data
Nov. 16, 2006 (KR) 10-2006-0113087

(51) Int. Cl. H04N 7/173

(52) U.S. Cl. 725/109; 725/116

(57) ABSTRACT

A broadcast service provider must transmit broadcast programs by dynamically reflecting real-time reconfiguration of broadcast timetables and broadcast programs of a plurality of broadcast program providers and the broadcast service provider.

A broadcast program providing apparatus and method for supporting dynamic delivery of program timetables and broadcast programs are provided. The apparatus includes a broadcast time organizer generating a third broadcast timetable by organizing broadcast times using a first broadcast timetable obtained by organizing broadcast times of first broadcast programs provided by a plurality of broadcast program providers or both the first broadcast timetable and a second broadcast timetable obtained by organizing broadcast times of second self-produced broadcast programs, and a broadcast program controller transmitting an exact broadcast program at an exact broadcast time according to the third broadcast timetable using the first broadcast programs received from the plurality of broadcast program providers or both the first broadcast programs and the second self-produced broadcast programs, which correspond to the third broadcast timetable. Thus, a broadcast service provider can transmit broadcast programs by dynamically reflecting real-time reconfiguration of broadcast timetables and broadcast programs of a plurality of broadcast program providers and the broadcast service provider.

### TECHNICAL FIELD

The present invention relates to a broadcast program providing apparatus and method for supporting dynamic delivery of program timetables and broadcast programs, and more particularly, to a broadcast program providing apparatus and method for dynamically and flexibly reflecting program timetables and broadcast programs provided by a plurality of broadcast program providers when a broadcast service provider receives the broadcast programs from the plurality of broadcast program providers.

### BACKGROUND ART

An Internet TV system provides a broadcast service using Internet Protocol (IP) and has the advantage of providing the broadcast service very cheaply. The Internet TV system generally has a program timetable and transmits broadcast programs according to a given program timetable. Small and medium or private broadcast service providers are predicted to commonly use Internet TV systems, and need to build their systems cheaply and flexibly.

According to conventional technology, broadcast service providers or operators provide a broadcast service by editing and fixing a program timetable as preparation for a predetermined time duration in the future. However, in the case where a program timetable is previously fixed, the order and contents of broadcast programs to be transmitted are also fixed, so there is little flexibility in reconfiguration of the broadcast programs. For example, a broadcast service provider often runs a broadcast channel by receiving broadcast programs from a plurality of broadcast program providers. Since a program timetable of a broadcast service provider is fixed according to the conventional technology, real-time reconfiguration of program timetables and broadcast programs performed by a plurality of broadcast program providers cannot be dynamically reflected.

A related conventional technique is a method and system for providing a broadcast service by combining broadcast programs received from a plurality of broadcast program providers into a single channel. In the prior art, a broadcast service operator, i.e. a broadcast service provider, receives broadcast programs independently from a plurality of broadcast program providers and transmits the broadcast programs based on a program timetable input by the broadcast service operator. Thus, there is the limitation that broadcast programming is fixed according to the program timetable input by the broadcast service operator.

Another related conventional technique is an Internet multicast channel dealing service system and method. In the prior art, a multicast broadcaster buys channels and their broadcast time and provides broadcast programs to a program management server, and a broadcast service operator, i.e. a broadcast service provider, transmits broadcast programs according to a channel configuration and a program time configuration determined by the broadcast service operator. Thus, there is the limitation that broadcast programming is fixed according to the channel configuration and the program time configuration determined by the broadcast service operator.

Another related conventional technique is a multicast rebroadcast service method and apparatus in an Internet broadcast system. In the prior art, in order to integrate a plurality of rebroadcast servers in which rebroadcast content is stored, a service broker controls a media gateway and a broadcast server at a proper time according to a pre-set broadcast schedule. Thus, since the service broker transmits broadcast programs according to the pre-set broadcast schedule, there is the limitation that broadcast programming is fixed.

### DETAILED DESCRIPTION OF THE INVENTION

### Technical Problem

The present invention provides a broadcast program providing apparatus and method for dynamically and flexibly reflecting program timetables and broadcast programs provided by a plurality of broadcast program providers when a broadcast service provider receives the broadcast programs from the plurality of broadcast program providers, in order to overcome the limitation that broadcast programming is fixed by a broadcast service provider.

### Technical Solution

According to an aspect of the present invention, there is provided a broadcast program providing apparatus for supporting dynamic delivery of program timetables and broadcast programs, the apparatus comprising: a broadcast time organizer generating a third broadcast timetable by organizing broadcast times using a first broadcast timetable obtained by organizing broadcast times of first broadcast programs provided by a plurality of broadcast program providers or both the first broadcast timetable and a second broadcast timetable obtained by organizing broadcast times of second self-produced broadcast programs; and a broadcast program controller transmitting an exact broadcast program at an exact broadcast time according to the third broadcast timetable using the first broadcast programs received from the plurality of broadcast program providers or both the first broadcast programs and the second self-produced broadcast programs, which correspond to the third broadcast timetable.

The broadcast time organizer may comprise: a table receiver receiving the first broadcast timetable obtained by organizing the broadcast times of the first broadcast programs provided by the plurality of broadcast program providers; a table input unit receiving the second broadcast timetable obtained by organizing the broadcast times of the second self-produced broadcast programs; and a table generator generating the third broadcast timetable by organizing broadcast times of broadcast programs to be provided using the first broadcast timetable or both the first broadcast timetable and the second broadcast timetable.

The table receiver may receive the first broadcast timetable by requesting to access the first broadcast timetable corresponding to a time duration previously reserved with the plurality of broadcast program providers.

The broadcast time organizer may further comprise a table notice unit notifying of the third broadcast timetable on a website.

The broadcast time organizer may further comprise a table transmitter transmitting the third broadcast timetable to other broadcast service providers.

The broadcast program controller may comprise: a program receiver receiving the first broadcast programs corresponding to the third broadcast timetable from the plurality of broadcast program providers; a program input unit receiving the second self-produced broadcast programs; a program generator sequentially generating broadcast programs according to the third broadcast timetable using the first broadcast timetable or both the first broadcast timetable and the second broadcast timetable; and a broadcast program transmitter transmitting the generated broadcast programs through a wired or wireless network using a broadcast channel through which the generated broadcast programs will be provided.

The program receiver may receive the first broadcast programs using a method selected from among a method of trying to access each of the plurality of broadcast program providers and a method of each of the plurality of broadcast program providers trying to access the apparatus, by considering the state, such as the bandwidth and data rate, of a network through which the first broadcast programs are received.

The broadcast program controller may further comprise a program transmitter transmitting the generated broadcast programs to other broadcast service providers.

The first broadcast timetable may comprise a program identification (ID), a time duration (a start time and an end time), and an address (an IP address or a Transmission Control Protocol (TCP) or User Datagram Protocol (UDP) port number) of a broadcast program provider with respect to each broadcast program.

The first broadcast timetable may be represented using an exclusive format or an eXtensible Markup Language (XML) format.

According to another aspect of the present invention, there is provided a broadcast program providing method of supporting dynamic delivery of program timetables and broadcast programs, the method comprising: (a) generating a third broadcast timetable by organizing broadcast times using a first broadcast timetable obtained by organizing broadcast times of first broadcast programs provided by a plurality of broadcast program providers or both the first broadcast timetable and a second broadcast timetable obtained by organizing broadcast times of second self-produced broadcast programs; and (b) transmitting an exact broadcast program at an exact broadcast time according to the third broadcast timetable using the first broadcast programs received from the plurality of broadcast program providers or both the first broadcast programs and the second self-produced broadcast programs, which correspond to the third broadcast timetable.

Operation (a) may comprise: (a-1) receiving the first broadcast timetable obtained by organizing the broadcast times of the first broadcast programs provided by the plurality of broadcast program providers; (a-2) receiving the second broadcast timetable obtained by organizing the broadcast times of the second self-produced broadcast programs; and (a-3) generating the third broadcast timetable by organizing broadcast times of broadcast programs to be provided using the first broadcast timetable or both the first broadcast timetable and the second broadcast timetable.

Operation (a-1) may receive the first broadcast timetable by requesting to access the first broadcast timetable corresponding to a time duration previously reserved with the plurality of broadcast program provider.

Operation (a) may further comprise notifying of the third broadcast timetable on a website.

Operation (a) may further comprise transmitting the third broadcast timetable to other broadcast service providers.

Operation (b) may comprise: (b-1) receiving the first broadcast programs corresponding to the third broadcast timetable from the plurality of broadcast program providers; (b-2) receiving the second self-produced broadcast programs; (b-3) sequentially generating broadcast programs according to the third broadcast timetable using the first broadcast timetable or both the first broadcast timetable and the second broadcast timetable; and (b-4) transmitting the generated broadcast programs through a wired or wireless network using a broadcast channel through which the generated broadcast programs will be provided.

Operation (b-1) may comprise receiving the first broadcast programs using a method selected from among a method of trying to access each of the plurality of broadcast program providers and a method of each of the plurality of broadcast program providers trying to access the apparatus, by considering the state, such as the bandwidth and data rate, of a network through which the first broadcast programs are received.

Operation (b) may further comprise transmitting the generated broadcast programs to other broadcast service providers.

The first broadcast timetable may comprise a program identification (ID), a time duration (a start time and an end time), and an address (an IP address or a Transmission Control Protocol (TCP) or User Datagram Protocol (UDP) port number) of a broadcast program provider with respect to each broadcast program.

The first broadcast timetable may be represented using an exclusive format or an eXtensible Markup Language (XML) format.

### ADVANTAGEOUS EFFECTS

According to the present invention, a broadcast service provider can transmit broadcast programs by dynamically reflecting real-time reconfiguration of broadcast timetables and broadcast programs of a plurality of broadcast program providers and the broadcast service provider.

### DESCRIPTION OF THE DRAWINGS

The above and other features and advantages of the present invention will become more apparent by describing in detail exemplary embodiments thereof with reference to the attached drawings in which:

FIG. 1 illustrates a connection structure in a network of a broadcast program providing apparatus according to an embodiment of the present invention;

FIG. 2 is a block diagram of a broadcast program providing apparatus according to an embodiment of the present invention;

FIG. 3 is a diagram for describing a process where a broadcast service provider dynamically receives broadcast programs from two broadcast program providers according to an embodiment of the present invention;

FIG. 4 is a signaling diagram illustrating a process of organizing a broadcast timetable and providing broadcast programs according to an embodiment of the present invention;

FIG. 5 is a flowchart illustrating a method of generating a broadcast timetable and transmitting broadcast programs;

FIG. 6 is a flowchart illustrating a process of generating a broadcast timetable in the method illustrated in FIG. 5; and

FIG. 7 is a flowchart illustrating a process of transmitting broadcast programs in the method illustrated in FIG. 5.

### BEST MODE

According to an aspect of the present invention, there is provided a broadcast program providing apparatus for supporting dynamic delivery of program timetables and broadcast programs, the apparatus comprising: a broadcast time organizer generating a third broadcast timetable by organizing broadcast times using a first broadcast timetable obtained by organizing broadcast times of first broadcast programs provided by a plurality of broadcast program providers or both the first broadcast timetable and a second broadcast timetable obtained by organizing broadcast times of second self-produced broadcast programs; and a broadcast program controller transmitting an exact broadcast program at an exact broadcast time according to the third broadcast timetable using the first broadcast programs received from the plurality of broadcast program providers or both the first broadcast programs and the second self-produced broadcast programs, which correspond to the third broadcast timetable.

### MODE OF THE INVENTION

The present invention will now be described in detail by explaining preferred embodiments of the invention with reference to the attached drawings.

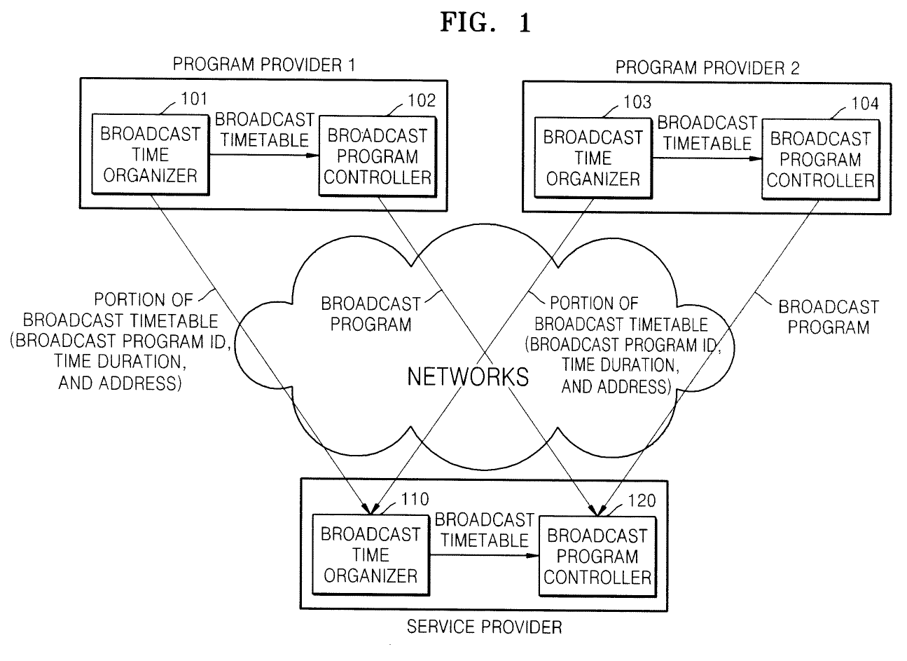

FIG. 1 illustrates a connection structure in a network of a broadcast program providing apparatus according to an embodiment of the present invention. In FIG. 1, the structure of a broadcast program providing apparatus of broadcast program providers is shown the same as the structure of a broadcast program providing apparatus of a broadcast service provider, for convenience of description.

Referring to FIG. 1, the broadcast program providing apparatus includes a broadcast time organizer 110 and a broadcast program controller 120. Broadcast time organizers 101 and 103 of a plurality of broadcast program providers each transmit a portion of a broadcast timetable corresponding to a time duration previously reserved, to the broadcast time organizer 110 of the broadcast service provider. The broadcast time organizer 110 of the broadcast service provider generates a broadcast timetable of a broadcast channel using a plurality of portions of the broadcast timetables or both the plurality of portions of the broadcast timetables and a portion of a self-produced broadcast timetable, and transmits the generated broadcast timetable to the broadcast program controller 120.

The broadcast program controller 120 of the broadcast service provider receives broadcast programs from broadcast program controllers 102 and 104 of the plurality of broadcast program providers or from itself and transmits the broadcast programs of the broadcast channel, based on the generated broadcast timetable.

In this case, the portions of the broadcast timetables provided by the broadcast program providers are transmitted to the broadcast service provider earlier than the broadcast programs provided by the broadcast program providers.

Each of the portions of the broadcast timetables provided by the broadcast program providers must include a program identification (ID), a time duration (a start time and an end time), and an address (an IP address or a Transmission Control Protocol (TCP) or User Datagram Protocol (UDP) port number) of a broadcast program provider with respect to each broadcast program, and is represented using a pre-set exclusive format or an eXtensible Markup Language (XML) format.

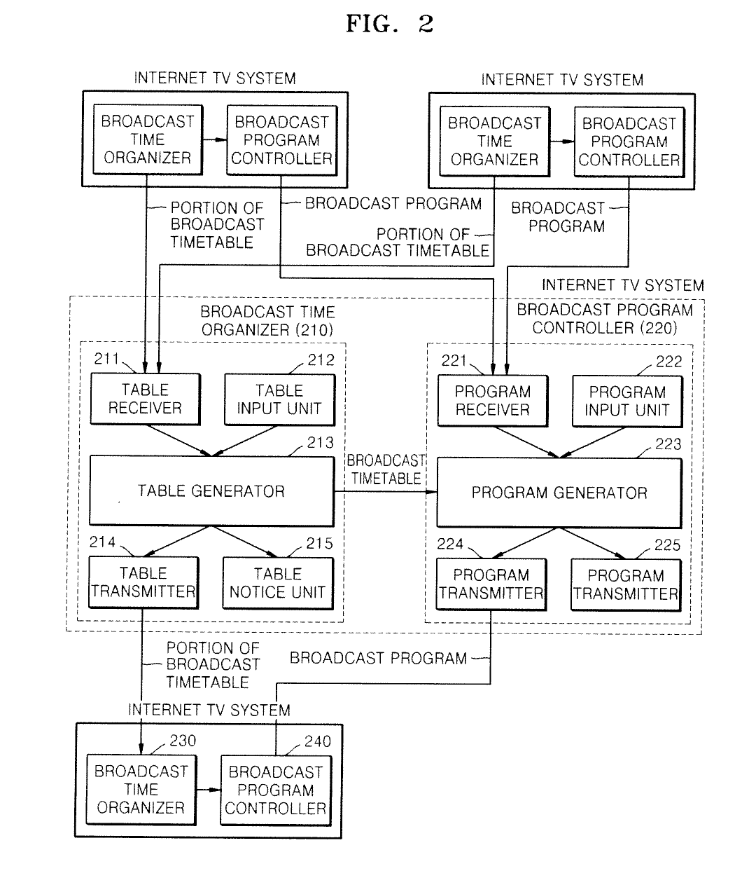

FIG. 2 is a block diagram of a broadcast program providing apparatus according to an embodiment of the present invention. Referring to FIG. 2, the broadcast program providing apparatus includes a broadcast time organizer 210 and a broadcast program controller 220. The broadcast time organizer 210 includes a table receiver 211, a table input unit 212, a table generator 213, a table transmitter 214, and a table notice unit 215, and the broadcast program controller 220 includes a program receiver 221, a program input unit 222, a program generator 223, a program transmitter 224, and a program transmitter 225.

The structure of a broadcast program providing apparatus of broadcast program providers is shown the same as the structure of a broadcast program providing apparatus of a broadcast service provider, for convenience of description, and some modules may be omitted if not relevant.

The table receiver 211 receives a portion of a broadcast timetable from each of a plurality of broadcast program providers.

The table input unit 212 supports to input a portion of a self-produced broadcast timetable.

The table generator 213 generates a broadcast timetable of a broadcast channel using the portions of the broadcast timetables received by the table receiver 211 and the table input unit 212.

The table notice unit 215 notifies of the broadcast timetable generated by the table generator 213 through a website.

The table transmitter 214 transmits the broadcast timetable generated by the table generator 213 to other broadcast service providers.

The program receiver 221 receives relevant broadcast programs from relevant broadcast program providers based on the broadcast timetable generated by the table generator 213.

The program input unit 222 allows the broadcast service provider to provide self-produced broadcast programs based on the broadcast timetable generated by the table generator 213.

The program generator 223 sequentially generates broadcast programs of a broadcast channel using the program receiver 221 and the program input unit 222, based on the broadcast timetable generated by the table generator 213.

The broadcast program transmitter 225 transmits the broadcast programs generated by the program generator 223 through a wired or wireless network.

The program transmitter 224 transmits a portion of the broadcast programs generated by the program generator 223 to other broadcast service providers.

A table transmitter 214 of each of the broadcast program providers transmits a portion of a broadcast timetable to the table receiver 211 of the broadcast service provider, and a program transmitter 224 of each of the broadcast program providers transmits broadcast programs to the program receiver 221 of the broadcast service provider.

The broadcast service provider needs access control since the broadcast service provider receives information from the plurality of the broadcast program providers. The table receiver 211 of the broadcast service provider performs the access control by granting authorization to transmit a broadcast timetable to the plurality of the broadcast program providers based on a time duration previously reserved by the plurality of the broadcast program providers.

In this case, when the program receiver 221 of the broadcast service provider receives broadcast programs from the broadcast program providers, the program receiver 221 of the broadcast service provider performs the access control by granting authorization to transmit the broadcast programs to the broadcast program providers using information, such as a program identification (ID), a time duration (a start time and an end time), and an address (an IP address or a TCP or UDP port number) of a broadcast program provider with respect to each broadcast program, in the generated broadcast timetable.

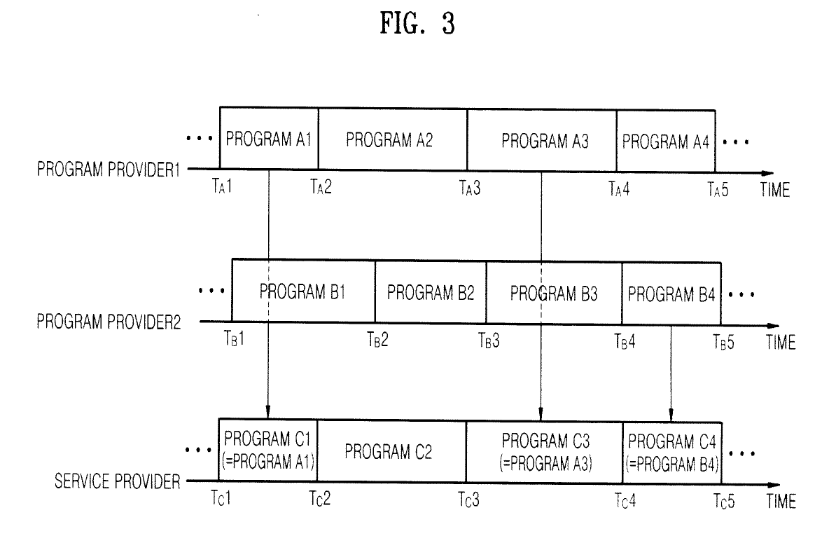

FIG. 3 is a diagram for describing a process where a broadcast service provider dynamically receives broadcast programs from two broadcast program providers according to an embodiment of the present invention.

Referring to FIG. 3, in the broadcast programs of the broadcast service provider, a program C1 (start time: T_{C}1, end time: T_{C}2) is a program A1 (start time: T_{A}1, end time: T_{A}2) provided by a first broadcast program provider, a program C2 (start time: T_{C}2, end time: T_{C}3) is self-produced, a program C3 (start time: T_{C}3, end time: T_{C}4) is a program A3 (start time: T_{A}3, end time: T_{A}4) provided by the first broadcast program provider, and a program C4 (start time: T_{C}4, end time: T_{C}5) is a program B4 (start time: T_{B}4, end time: T_{B}5) provided by a second broadcast program provider.

As described above, a broadcast timetable and a broadcast program configuration of the broadcast service provider are dynamically associated with broadcast timetables and broadcast program configurations of the broadcast program providers. Thus, the broadcast service provider can transmit broadcast programs by dynamically reflecting real-time reconfiguration of broadcast timetables and broadcast programs of a plurality of broadcast program providers and the broadcast service provider.

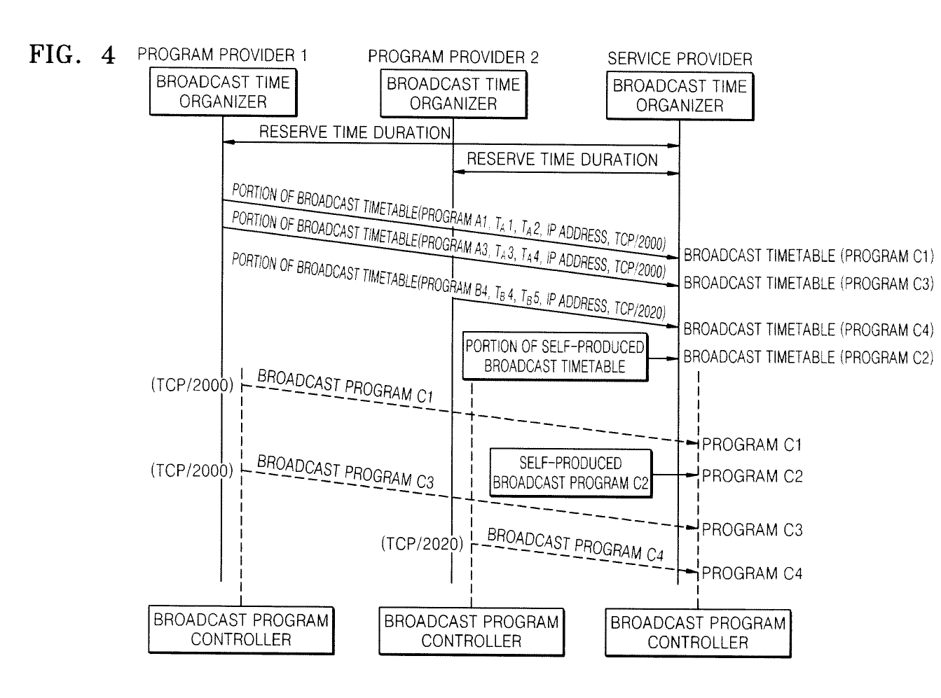

FIG. 4 is a signaling diagram illustrating a process of organizing a broadcast timetable and providing broadcast programs with reference to FIG. 3, according to an embodiment of the present invention.

Referring to FIG. 4, the broadcast service provider previously performs reservation of a time duration with the two broadcast program providers. A broadcast time organizer (referring to FIGS. 1 and 2) of the broadcast service provider receives a plurality of portions of broadcast timetables from broadcast time organizers of the broadcast program providers. The broadcast time organizer of the broadcast service provider generates a broadcast timetable using the received portions of broadcast timetables and a portion of a self-produced broadcast timetable, and transmits the generated broadcast timetable to a broadcast program controller of the broadcast service provider.

The broadcast program controller of the broadcast service provider receives an exact broadcast program from an exact IP address at an exact time using information, such as a program identification (ID), a time duration (a start time and an end time), and an address (an IP address or a TCP or UDP port number) of a broadcast program provider with respect to each broadcast program, in the generated broadcast timetable.

In this case, the portions of the broadcast timetables provided by the broadcast program providers are transmitted to the broadcast service provider earlier than the broadcast programs provided by the broadcast program providers.

When the broadcast service provider receives the portions of the broadcast timetables or the broadcast programs from the broadcast program providers, the broadcast service provider can selectively use a pull type connection by which the broadcast service provider tries to access each of the broadcast program providers, or a push type connection by which each of the broadcast program providers tries to access the broadcast service provider, according to the network and system state.

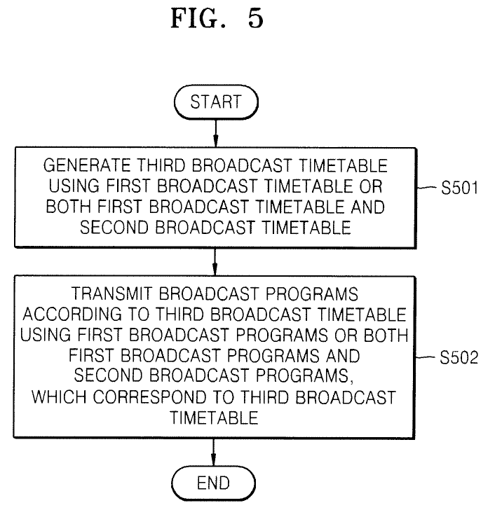

FIG. 5 is a flowchart illustrating a method of generating a broadcast timetable and transmitting broadcast programs.

Referring to FIG. 5, a third broadcast timetable is generated in operation S501 by organizing broadcast times using a first broadcast timetable obtained by organizing broadcast times of first broadcast programs provided by a plurality of broadcast program providers or both the first broadcast timetable and a second broadcast timetable obtained by organizing broadcast times of second self-produced broadcast programs.

In operation S502, an exact broadcast program is transmitted at an exact broadcast time according to the third broadcast timetable using the first broadcast programs received from the broadcast program providers or both the first broadcast programs and the second self-produced broadcast programs, which correspond to the third broadcast timetable.

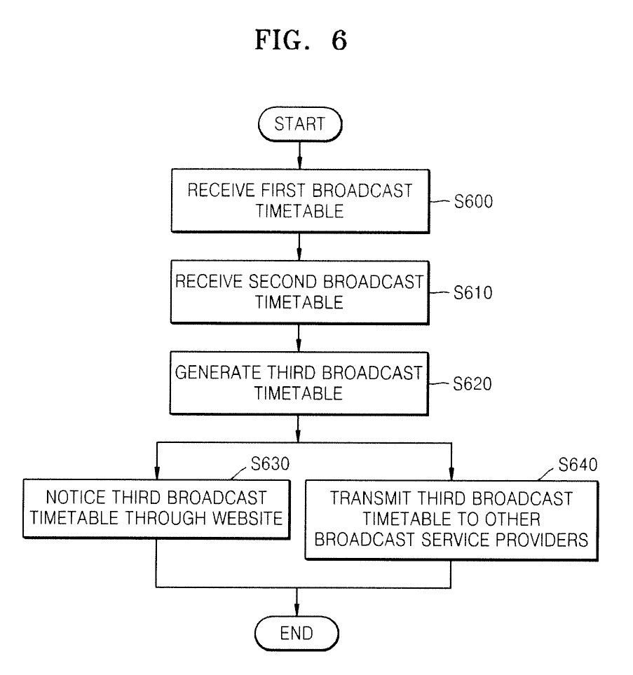

FIG. 6 is a flowchart illustrating a process of generating a broadcast timetable in the method illustrated in FIG. 5.

Referring to FIG. 6, the first broadcast timetable obtained by organizing the broadcast times of the first broadcast programs provided by the broadcast program providers is received in operation S600, and the second broadcast timetable obtained by organizing the broadcast times of the second self-produced broadcast programs is received in operation S610.

In operation S620, the third broadcast timetable is generated by organizing broadcast times of broadcast programs to be provided using the first broadcast timetable or both the first broadcast timetable and the second broadcast timetable.

In operation S630, the third broadcast timetable is noticed through (what does this mean?) a website.

In operation S640, the third broadcast timetable may be transmitted to other broadcast service providers.

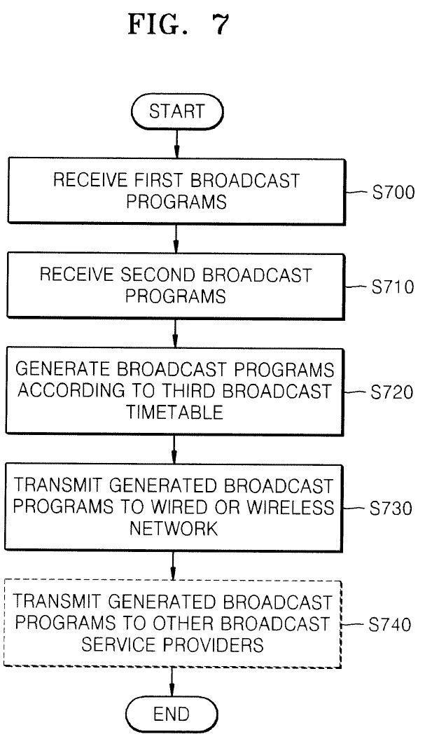

FIG. 7 is a flowchart illustrating a process of transmitting broadcast programs in the method illustrated in FIG. 5.

Referring to FIG. 7, the first broadcast programs corresponding to the third broadcast timetable are received from the broadcast program providers in operation S700, and the second self-produced broadcast programs are received in operation S710.

In operation S720, broadcast programs according to the third broadcast timetable are sequentially generated using the first broadcast timetable or both the first broadcast timetable and the second broadcast timetable.

In operation S730, the generated broadcast programs are transmitted through a wired or wireless network using a broadcast channel through which the generated broadcast programs will be provided.

In operation S740 the generated broadcast programs may be transmitted to other broadcast service providers.

The invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and detail may be made therein without departing from the spirit and scope of the present invention as defined by the following claims.

### INDUSTRIAL APPLICABILITY

As described above, according to the present invention, a broadcast service provider can transmit broadcast programs by dynamically reflecting real-time reconfiguration of broadcast timetables and broadcast programs of a plurality of broadcast program providers and the broadcast service provider.

1. A broadcast program providing apparatus for supporting dynamic delivery of program timetables and broadcast programs, the apparatus comprising:
a broadcast time organizer generating a third broadcast timetable by organizing broadcast times using a first broadcast timetable obtained by organizing broadcast times of first broadcast programs provided by a plurality of broadcast program providers or both the first broadcast timetable and a second broadcast timetable obtained by organizing broadcast times of second self-produced broadcast programs; and
a broadcast program controller transmitting an exact broadcast program at an exact broadcast time according to the third broadcast timetable using the first broadcast programs received from the plurality of broadcast program providers or both the first broadcast programs and the second self-produced broadcast programs, which correspond to the third broadcast timetable.

2. The apparatus of claim 1, wherein the broadcast time organizer comprises:
a table receiver receiving the first broadcast timetable obtained by organizing the broadcast times of the first broadcast programs provided by the plurality of broadcast program providers;
a table input unit receiving the second broadcast timetable obtained by organizing the broadcast times of the second self-produced broadcast programs; and
a table generator generating the third broadcast timetable by organizing broadcast times of broadcast programs to be provided using the first broadcast timetable or both the first broadcast timetable and the second broadcast timetable.

3. The apparatus of claim 2, wherein the table receiver receives the first broadcast timetable by requesting access to the first broadcast timetable corresponding to a time duration previously reserved with the plurality of broadcast program providers.

4. The apparatus of claim 2, wherein the broadcast time organizer further comprises a table notice unit notifying of the third broadcast timetable on a website.

5. The apparatus of claim 2, wherein the broadcast time organizer further comprises a table transmitter transmitting the third broadcast timetable to other broadcast service providers.

6. The apparatus of claim 1, wherein the broadcast program controller comprises:
a program receiver receiving the first broadcast programs corresponding to the third broadcast timetable from the plurality of broadcast program providers;
a program input unit receiving the second self-produced broadcast programs;
a program generator sequentially generating broadcast programs according to the third broadcast timetable using the first broadcast timetable or both the first broadcast timetable and the second broadcast timetable; and
a broadcast program transmitter transmitting the generated broadcast programs through a wired or wireless network using a broadcast channel through which the generated broadcast programs will be provided.

7. The apparatus of claim 6, wherein the program receiver receives the first broadcast programs using a method selected from among a method of trying to access each of the plurality of broadcast program providers and a method of each of the plurality of broadcast program providers trying to access the apparatus, by considering a state, such as a bandwidth and a data rate, of a network through which the first broadcast programs are received.

8. The apparatus of claim 6, wherein the broadcast program controller further comprises a program transmitter transmitting the generated broadcast programs to other broadcast service providers.

9. The apparatus of claim 1, wherein the first broadcast timetable comprises a program identification (ID), a time duration (a start time and an end time), and an address (an IP address or a Transmission Control Protocol (TCP) or User Datagram Protocol (UDP) port number) of a broadcast program provider with respect to each broadcast program.

10. The apparatus of claim 9, wherein the first broadcast timetable is represented using an exclusive format or an eXtensible Markup Language (XML) format.

11. A broadcast program providing method of supporting dynamic delivery of program timetables and broadcast programs, the method comprising:
(a) generating a third broadcast timetable by organizing broadcast times using a first broadcast timetable obtained by organizing broadcast times of first broadcast programs provided by a plurality of broadcast program providers or both the first broadcast timetable and a second broadcast timetable obtained by organizing broadcast times of second self-produced broadcast programs; and
(b) transmitting an exact broadcast program at an exact broadcast time according to the third broadcast timetable using the first broadcast programs received from the plurality of broadcast program providers or both the first broadcast programs and the second self-produced broadcast programs, which correspond to the third broadcast timetable.

12. The method of claim 11, wherein (a) comprises:
(a-1) receiving the first broadcast timetable obtained by organizing the broadcast times of the first broadcast programs provided by the plurality of broadcast program providers;
(a-2) receiving the second broadcast timetable obtained by organizing the broadcast times of the second self-produced broadcast programs; and
(a-3) generating the third broadcast timetable by organizing broadcast times of broadcast programs to be provided using the first broadcast timetable or both the first broadcast timetable and the second broadcast timetable.

13. The method of claim 12, wherein (a-1) comprises receiving the first broadcast timetable by requesting access to the first broadcast timetable corresponding to a time duration previously reserved with the plurality of broadcast program provider.

14. The method of claim 12, wherein (a) further comprises notifying of the third broadcast timetable on a website.

15. The method of claim 12, wherein (a) further comprises transmitting the third broadcast timetable to other broadcast service providers.

16. The method of claim 11, wherein (b) comprises:
(b-1) receiving the first broadcast programs corresponding to the third broadcast timetable from the plurality of broadcast program providers;
(b-2) receiving the second self-produced broadcast programs;
(b-3) sequentially generating broadcast programs according to the third broadcast timetable using the first broadcast timetable or both the first broadcast timetable and the second broadcast timetable; and
(b-4) transmitting the generated broadcast programs through a wired or wireless network using a broadcast channel through which the generated broadcast programs will be provided.

17. The method of claim 16, wherein (b-1) comprises receiving the first broadcast programs using a method selected from among a method of trying to access each of the plurality of broadcast program providers and a method of each of the plurality of broadcast program providers trying to access the apparatus, by considering a state, such as a bandwidth and a data rate, of a network through which the first broadcast programs are received.

18. The method of claim 16, wherein (b) further comprises transmitting the generated broadcast programs to other broadcast service providers.

19. The method of claim 11, wherein the first broadcast timetable comprises a program identification (ID), a time duration (a start time and an end time), and an address (an IP address or a Transmission Control Protocol (TCP) or User Datagram Protocol (UDP) port number) of a broadcast program provider with respect to each broadcast program.

20. The method of claim 19, wherein the first broadcast timetable is represented using an exclusive format or an eXtensible Markup Language (XML) format.

21. A computer readable recording medium storing a computer readable program for executing the method of any one of claims 11 through 20.
